(19) United States
(12) Patent Application Publication
(10) Pub. No.: US 2018/0173540 A1
(43) Pub. Date: Jun. 21, 2018

(54) PROGRAM EXECUTION SYSTEM AND METHOD FOR LAUNCHING RESIDENT PROGRAMS

(71) Applicant: MITSUBISHI ELECTRIC CORPORATION, Tokyo (JP)

(72) Inventors: Kohei TANAKA, Tokyo (JP); Akira TOYOOKA, Tokyo (JP); Tetsuji FUJISAKI, Tokyo (JP); Mitsuo SHIMOTANI, Tokyo (JP)

(73) Assignee: MITSUBISHI ELECTRIC CORPORATION, Tokyo (JP)

(21) Appl. No.: 15/329,195

(22) PCT Filed: Aug. 7, 2014
(86) PCT No.: PCT/JP2014/070891

§ 371 Date: Jan. 25, 2017

(51) Int. Cl. G06F 9/445; G06F 9/50

(52) U.S. Cl. CPC G06F 9/44505; G06F 9/5016

(57) ABSTRACT

A program execution system includes a program execution unit that executes a plurality of programs including a plurality of resident programs, and a resident program launch controller that controls a sequence in which a plurality of the resident programs is launched. The program execution unit sequentially launches the plurality of resident programs, at system startup, according to a launch sequence definition that is information specifying a sequence in which the plurality of the resident programs is to be launched. If the amount of resources being used exceeds a certain value due to the launch of the plurality of resident programs, the resident program launch controller modifies the launch sequence definition at the current system startup and uses the modified launch sequence definition at the next system startup.

### TECHNICAL FIELD

The present invention relates to a program execution system, and more particularly to a method for launching resident programs.

### BACKGROUND ART

As a device (program execution device) provided with a program execution system, such as a smartphone or a tablet terminal, those into which an application can freely be introduced (installed) by a user have been widespread, for example. Further, applications that can be introduced by a user include an application including a program (resident program) which is automatically launched at startup of a system and resides in the system. Due to a resident program residing in a system, reduction in an operation burden on a user and continuous service are implemented.

However, in the case where a user introduces a lot of applications into a program execution device, if the resident programs thereof are launched without any limitation, resources (memory capacity or a processing speed of a central processing unit (CPU)) of the program execution device become insufficient, and therefore, it is feared that the applications cannot normally be executed. To address such problem, a general program execution device limits a type of applications allowed to reside, or force-quits an application with low priority when a free space of memory is decreased.

Further, Patent Document 1 below discloses a technology of automatically switching an application to be launched according to a time at which a system is started. Patent Document 2 discloses a technology in which applications are classified into a resident type and a non-resident type (temporary type), and when memory shortage of an information terminal device occurs, a non-resident type application is force quitted. Patent Document 3 discloses a technology of determining priority of each application on the basis of the use frequency thereof.

### PRIOR ART DOCUMENTS

### Patent Documents

Patent Document 1: Japanese Patent Application Laid-Open No. 2004-157781
Patent Document 2: Japanese Patent Application Laid-Open No. 2003-15892
Patent Document 3: Japanese Patent Application Laid-Open No. 2013-246770

### SUMMARY OF INVENTION

### Problems to be Solved by the Invention

In a conventional program execution device, a sequence in which resident programs are launched at system startup is the same every time. Therefore, if resource shortage occurs due to a resident program, only the same resident program is launched every time. In other words, there is a resident program that is not launched at all. However, resident programs include the one having a substantial need to be periodically launched, such as an automatic update program of an application, and therefore, it is undesirable that there is a resident program which is not launched at all.

The present invention is accomplished to solve the problems described above, and aims to provide a program execution system that can prevent the generation of a resident program which is not launched at all.

### Means for Solving the Problems

A program execution system according to the present invention includes a program execution unit configured to execute a plurality of programs including a plurality of resident programs; and a resident program launch controller configured to control a sequence in which the plurality of resident programs is launched, wherein the program execution unit sequentially launches the plurality of resident programs, at system startup, according to a launch sequence definition that is information specifying a sequence in which the plurality of resident programs is to be launched, and the resident program launch controller modifies the launch sequence definition at current system startup and uses the modified launch sequence definition at next system startup, when an amount of resources being used exceeds a certain value due to the launch of the plurality of resident programs.

### Effects of the Invention

According to the present invention, in the case where an amount of resources being used due to the launch of a resident program exceeds a certain value, the launch sequence definition modified from the launch sequence definition used at the current system startup is used at the next system startup, whereby, at the next system startup, the sequence in which a plurality of resident programs is launched is different from the launch sequence definition at the current system startup. This can prevent the generation of a resident program that is not launched at all.

The objects, features, aspects and advantages of the present invention will become more apparent with the following detailed description and the accompanying drawings.

### BRIEF DESCRIPTION OF DRAWINGS

FIG. 1 is a diagram illustrating the configuration of a program execution system according to the present invention.

FIG. 2 is a diagram illustrating the configuration of an application.

FIG. 3 is a diagram illustrating an example of a launch sequence definition.

FIG. 4 is a diagram for describing a memory capacity of a program execution device.

FIG. 5 is a diagram for describing an operation of the program execution device according to an embodiment 1.

FIG. 6 is a diagram illustrating a launch sequence definition after the operation illustrated in FIG. 5.

FIG. 7 is flowchart illustrating an operation of the program execution device according to the embodiment 1.

FIG. 8 is a flowchart illustrating an operation of the program execution device according to the embodiment 1, in the case where an amount of memory to be used by a resident program can be determined beforehand.

FIG. 9 is a diagram for describing an operation of the program execution device when a new application is introduced.

FIG. 10 is a diagram for describing an operation of the program execution device when a new application is introduced.

FIG. 11 is a diagram illustrating an example of a launch sequence definition after a new application is introduced.

FIG. 12 is a diagram for describing an operation of a program execution device according to an embodiment 2.

FIG. 13 is flowchart illustrating an operation of the program execution device according to the embodiment 2.

FIG. 14 is a diagram for describing an operation of a program execution device according to an embodiment 3.

FIG. 15 is a flowchart illustrating an operation of the program execution device according to the embodiment 3.

FIG. 16 is a diagram illustrating an example of a launch sequence definition according to an embodiment 4.

FIG. 17 is a diagram illustrating an example of a launch sequence definition according to the embodiment 4.

FIG. 18 is a diagram illustrating an example of a launch sequence definition according to the embodiment 4.

FIG. 19 is a flowchart illustrating an operation of a program execution device according to an embodiment 5.

FIG. 20 is a flowchart illustrating an operation of the program execution device according to the embodiment 5, in the case where an amount of memory to be used by a resident program can be determined beforehand.

FIG. 21 is a diagram for describing an operation of a program execution device according to an embodiment 6.

### DESCRIPTION OF EMBODIMENTS

### Embodiment 1

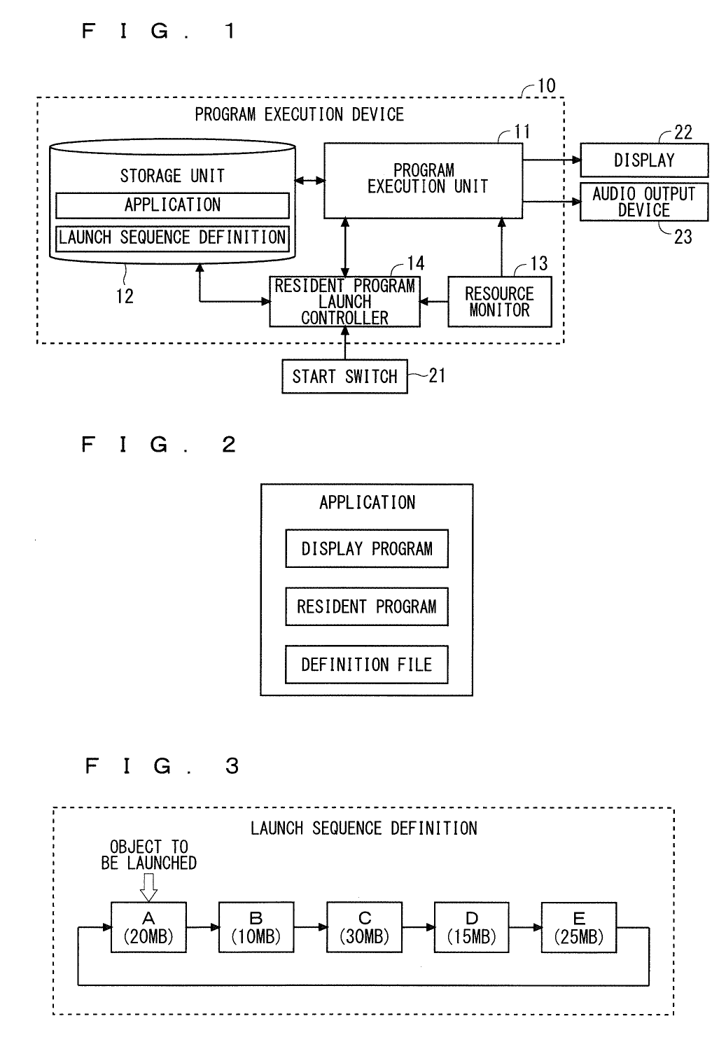

FIG. 1 is a diagram illustrating the configuration of a program execution system according to the present invention. The program execution system includes a program execution device 10, and a start switch 21, a display 22, and an audio output device 23 which are connected to the program execution device 10. While the present invention is widely applicable to program execution systems including personal computers, the present invention is more effectively applied to portable or compact devices (for example, smartphones, tablet terminals, on-vehicle information display devices, and navigation systems) having limited resources due to reasons such as production cost, product size, and power consumption.

The start switch 21 is a power source switch of the program execution device 10, and when a power source of the program execution device 10 is turned on by user's operation on the start switch 21, the program execution system is started. The start switch 21 may be a remote controller that remotely controls the program execution device 10, or may be built into the program execution device 10. Further, in the case where the program execution system is applied to an on-vehicle device, the start switch 21 may be configured to operate in conjunction with a power source switch or an ignition switch of a vehicle.

While a liquid crystal display is typical as the display 22, an arbitrary device (for example, a display unit of a smartphone, a tablet terminal, or an instrument panel of a vehicle) having an image display function may be used. In addition, the display 22 may be a touch panel functioning as an input receiving a user's operation. While a speaker or a headphone is typical as the audio output device 23, an arbitrary device having an audio output function may be used therefor.

The program execution device 10 includes a program execution unit 11, a storage unit 12, a resource monitor 13, and a resident program launch controller 14. The program execution device 10 is configured by using a computer, and the program execution unit 11, the resource monitor 13, and the resident program launch controller 14 are implemented by the computer operating according to a program. The storage unit 12 is constituted by a non-volatile storage medium such as a hard disk or a removable disk.

The program execution unit 11 can simultaneously execute a plurality of applications. In addition, the program execution unit 11 can output the execution result of each application from the display 22 or the audio output device 23 according to the operation of the application.

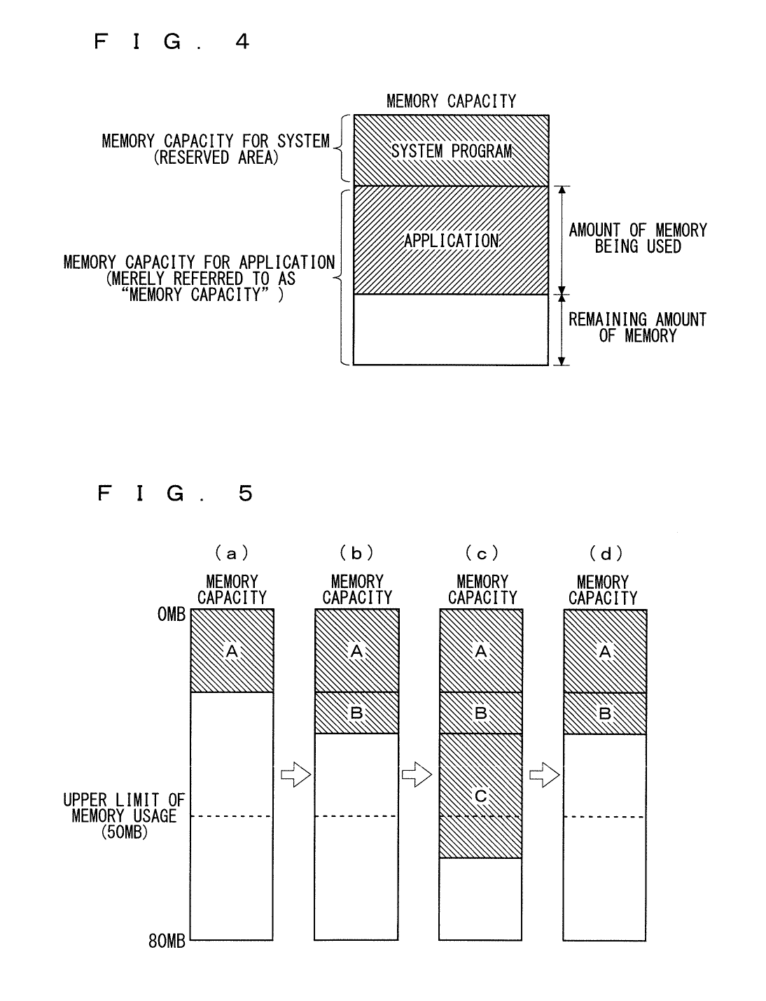

In general, an application executed by the program execution device is formed as a package including one or more programs and a definition file having various information pieces concerning the application. In addition, as illustrated in FIG. 2, a general application includes a display program having an execution screen displayed on the display 22, a resident program which is resident (in other words, which runs in the background) without being drawn on the display 22, and a definition file. Note that there are an application including a resident program and a definition file without including a display program and an application including a display program and a definition file without including a resident program. In addition, one application may include multiple display programs, resident programs, or definition files.

Examples of the resident program include a map update confirmation program for navigation, a post confirmation program for social networking service (SNS) application, a latest news acquiring program of a news application, an update confirmation program of a music application, and a latest information acquiring program of a weather report application.

An application executed by the program execution unit 11 is stored in the storage unit 12. It is supposed in this context that applications stored in the storage unit 12 include a plurality of applications including a resident program. Further, the program execution unit 11 launches the resident programs of the plurality of applications in a predefined sequence at system startup. A “launch sequence definition” is information specifying a sequence (resident program launch sequence) in which a plurality of resident programs is to be launched by the program execution unit 11. The launch sequence definition is stored in the storage unit 12, and read by the program execution unit 11 at system startup.

FIG. 3 is a diagram schematically illustrating the launch sequence definition stored in the storage unit 12. The example in FIG. 3 shows a sequence for launching resident programs A to E as the launch sequence definition. It is supposed in the present embodiment that the launch sequence definition specifies the sequence in which the resident programs are to be launched in a loop manner and includes information indicating a resident program which is an object to be launched.

In the case where the launch sequence definition illustrated in FIG. 3 is stored in the storage unit 12, the program execution unit 11 first launches the resident program A which is an object to be launched, and then, launches objects to be launched one by one according to the launch sequence definition. That is, the program execution unit 11 launches the resident programs A to E in the sequence of A, B, C, D, and E.

The resource monitor 13 monitors the use status of resource by each application. Examples of the information indicating the use status of resource include an amount of memory being used or CPU utilization. In the present embodiment, the resource monitor 13 is supposed to monitor an amount of memory being used in the program execution device 10.

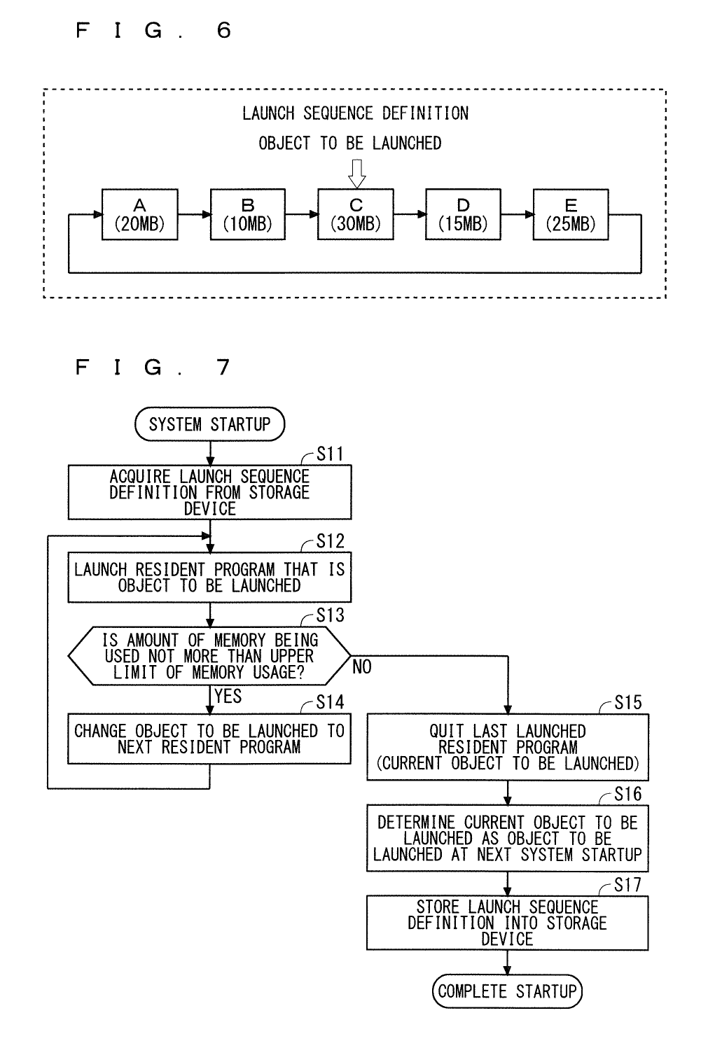

Here, programs executed by the program execution unit 11 include a program (system program) for implementing a basic operation of the program execution device 10 as well as a program included in an application introduced by a user. Since the system program has to be always executed, a part of the memory capacity of the program execution device 10 is reserved as an area for the system program, and the remaining part is used as an area for applications in general, as illustrated in FIG. 4. The “memory capacity” in the present specification indicates the capacity of the area for applications.

The resident program launch controller 14 controls the sequence (resident program launch sequence) in which a plurality of resident programs is to be launched. Specifically, in the case where memory shortage caused by the launch of a resident program at system startup is detected, the resident program launch controller 14 modifies the launch sequence definition used at the current system startup and uses the modified launch sequence definition at next system startup. That is, the resident program launch controller 14 updates the content of the launch sequence definition stored in the storage unit 12. Thus, the resident program launch sequence to be used at the next system startup is modified from the one at the current system startup.

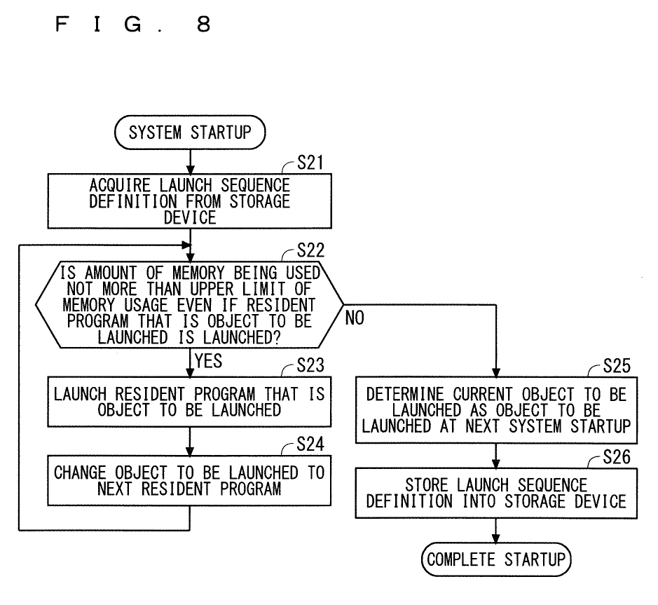

Next, the operation of the program execution device 10 at system startup will be described with reference to FIG. 5. FIG. 5 illustrates the operation of the program execution device 10 when it is assumed that the launch sequence definition in FIG. 3 is stored in the storage unit 12. It is supposed in this context that the memory capacity of the program execution device 10 is 80 MB, and the upper limit (upper limit of memory usage) of the memory capacity usable by resident programs is specified as 50 MB. That is, when an amount of memory used by resident programs exceeds 50 MB, it is determined that memory shortage occurs. Further, as illustrated in FIG. 3, the amount of memory to be used by each of the resident programs A, B, C, D, and E is 20 MB, 10 MB, 30 MB, 15 MB, and 25 MB, respectively.

When the power source of the program execution device 10 is turned on by the start switch 21 to start the system, the program execution unit 11 launches the resident program A that is an object to be launched according to the launch sequence definition (FIG. 3). As illustrated in part (a) of FIG. 5, launching the resident program A only uses the memory capacity of 20 MB lower than 50 MB which is the upper limit of memory usage. In this case, the program execution unit 11 changes the object to be launched from the resident program A to the resident program B according to the launch sequence definition, and launches the resident program B. As illustrated in part (b) of FIG. 5, even if the resident programs A and B are launched, the amount of memory being used is 30 MB which is still lower than the upper limit of memory usage. Therefore, the program execution unit 11 changes the object to be launched further from the resident program B to the resident program C, and launches the resident program C.

As illustrated in part (c) of FIG. 5, when the resident programs A, B, and C are launched, the amount of memory being used reaches 60 MB which exceeds the upper limit of memory usage, and thus, memory shortage occurs. In this case, the program execution unit 11 quits the resident program C (that is, the last launched resident program C) which is the cause for which the amount of memory being used exceeds the upper limit of memory usage to overcome the memory shortage as illustrated in part (d) of FIG. 5. Further, the resident program launch controller 14 updates the launch sequence definition stored in the storage unit 12 in such a manner that the resident program C which is the current object to be launched is to be launched first at the next system startup. That is, the resident program launch controller 14 stores the launch sequence definition in which the resident program C is the object to be launched as illustrated in FIG. 6 into the storage unit 12. Thus, at the next system startup, the operation similar to the above operation is performed after the resident program C is first launched by the program execution unit 11.

As described above, in the present embodiment, the content of the launch sequence definition is modified by changing the resident program, which is to be launched first, without modifying the loop of the launch sequence definition. Accordingly, any of the resident programs has a chance to be executed during the system is repeatedly started and shut down, and this prevents the generation of a resident program which is not at all launched.

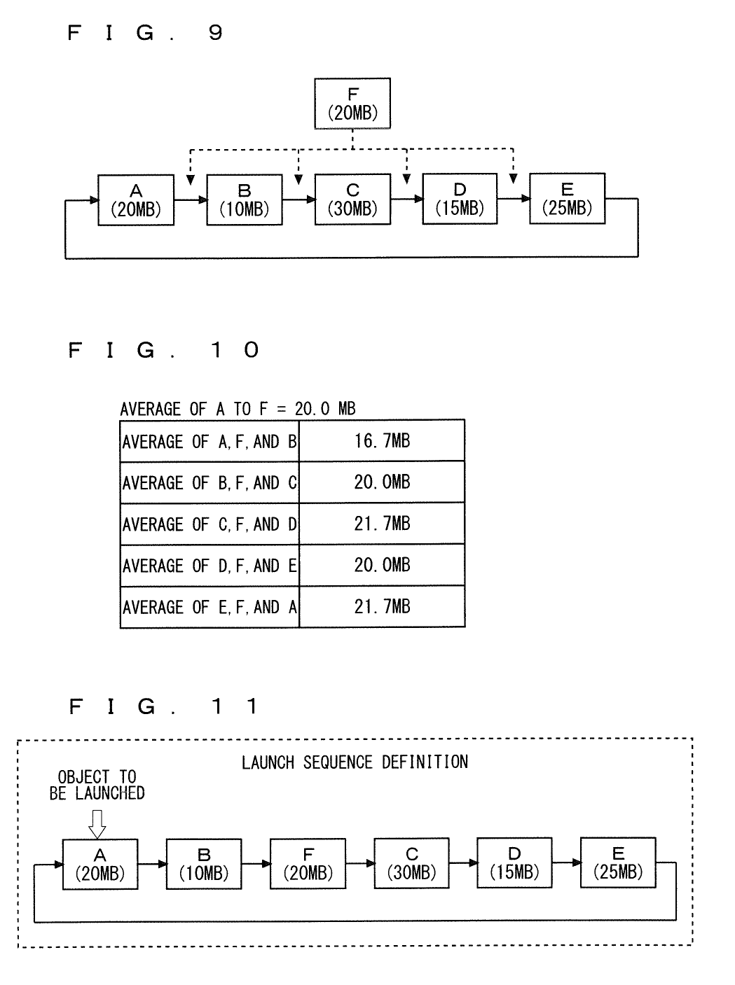

FIG. 7 is a flowchart illustrating the operation of the program execution device 10 according to the embodiment 1 at system startup. The operation described with reference to FIG. 5 is implemented by the program execution device 10 performing the operation according to the flowchart.

When the power source of the program execution device 10 is turned on by the start switch 21 to start the system, the program execution unit 11 acquires the launch sequence definition from the storage unit 12 (step S11), and launches a resident program that is an object to be launched (step S12). Then, the resource monitor 13 monitors an amount of memory being used in the program execution device 10 to confirm whether or not the amount of memory being used is not more than the upper limit of memory usage (step S13). If the amount of memory being used is not more than the upper limit of memory usage (YES in step S13), an object to be launched is changed to the next resident program (step S14), and then, the process returns to step S12.

If the amount of memory being used exceeds the upper limit of memory usage (NO in step S13), the program execution unit 11 quits the last launched resident program (step S15). Further, the resident program launch controller 14 determines the resident program, which is the current object to be launched, to be the object to be launched at the next system startup (step S16), and stores the launch sequence definition in which this resident program is the object to be launched in the storage unit 12 (step S17). Thus, the startup process of the system is completed.

In the above description, it is determined whether or not memory shortage occurs (step S13) after a resident program is actually launched (step S12). However, if an amount of memory to be used by each resident program is recognized in advance, it may be determined whether or not memory shortage will occur before the launch of a resident program. In this case, the resident program may be launched and reside only when it is determined that memory shortage will not occur.

For example, when information of an amount of memory to be used by a resident program is written on the definition file (FIG. 2) included in an application, the amount of memory to be used by the resident program can be determined in advance. Further, the information of an amount of memory to be used written on the definition file may be a measured value at the time of the previous launch of the resident program.

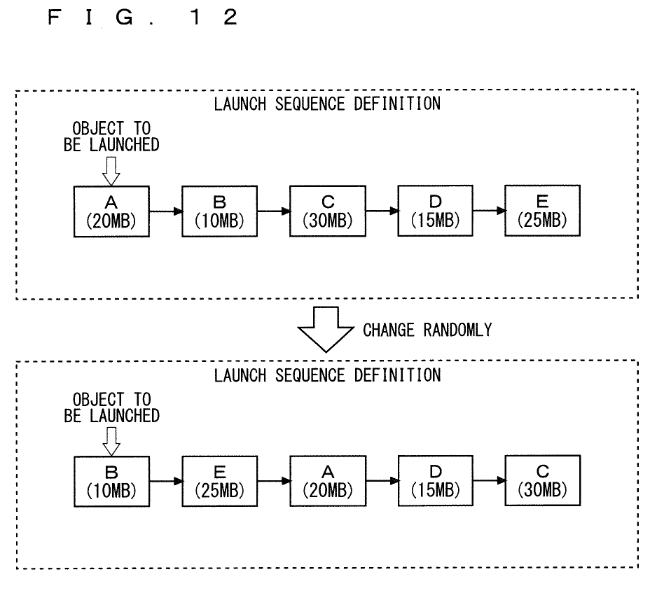

The operation of the program execution device 10 at system startup when an amount of memory to be used by a resident program can be determined beforehand will be described below in more detail. FIG. 8 is a flowchart illustrating this operation.

When the power source of the program execution device 10 is turned on by the start switch 21 to start the system, the program execution unit 11 acquires the launch sequence definition from the storage unit 12 (step S21). Then, the program execution unit 11 predicts an amount of memory to be used when the resident program which is the object to be launched is launched on the basis of the current amount of memory being used in the program execution device 10 detected by the resource monitor 13 and the amount of memory to be used by the resident program which is the object to be launched, and determines whether or not the amount of memory to be used at that time is not more than the upper limit of memory usage (step S22).

When determining that the amount of memory to be used is not more than the upper limit of memory usage even if the resident program which is the object to be launched is launched (YES in step S22), the program execution unit 11 launches this resident program (step S23). Then, the program execution unit 11 changes the object to be launched to the next resident program (step S24), and then, the process returns to step S22.

On the other hand, when determining that the amount of memory to be used exceeds the upper limit of memory usage when the resident program which is the object to be launched is launched (NO in step S22), the program execution unit 11 does not launch this resident program. In this case, the resident program launch controller 14 determines the resident program, which is the current object to be launched, to be the object to be launched at the next system startup (step S25), and stores the launch sequence definition in which this resident program is the object to be launched in the storage unit 12 (step S26). Thus, the startup process of the system is completed.

When a user introduces a new application into the program execution device 10, the resident program launch controller 14 adds the new resident program (F) to the sequence of the resident programs in the launch sequence definition stored in the storage unit 12 as illustrated in FIG. 9. A new application may be added at any position in the launch sequence definition. However, it is preferable that, for example, the new application may be added at a position where the average of amounts of memory to be used by the new resident program and the resident programs located before and after the new resident program becomes the closest to the average of the amounts of memory to be used by all resident programs included in the launch sequence definition. This can prevent an application having a large amount of memory to be used from being concentrated on a specific position, whereby more resident programs can be simultaneously executed.

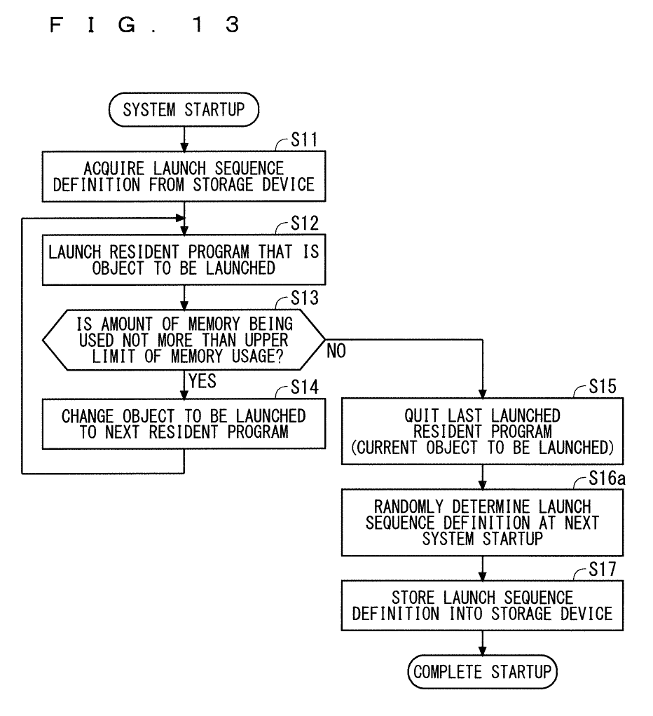

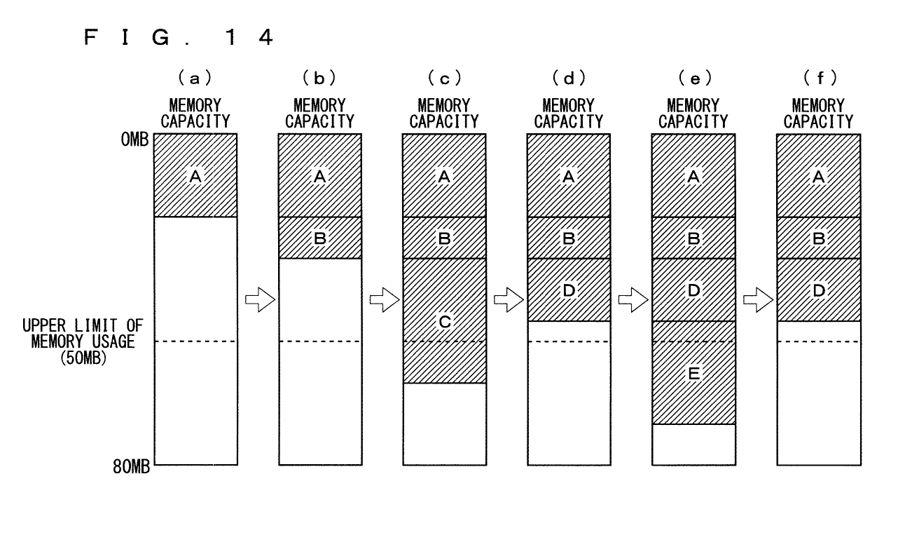

In the case where the amount of memory to be used by the new resident program F is 20 MB, the average of the amounts of memory to be used by all resident programs A to F included in the launch sequence definition after the addition of the resident program F is 20.0 MB as illustrated in FIG. 9. Further, as illustrated in FIG. 10, the average of the amounts of memory to be used by the new resident program F and the resident programs before and after the position where the new resident program F is to be added is as stated below. Specifically, when the resident program F is added between the resident programs A and B, the average becomes 16.7 MB; when the resident program F is added between the resident programs B and C, the average becomes 20.0 MB; when the resident program F is added between the resident programs C and D, the average becomes 21.7 MB; when the resident program F is added between the resident programs D and E, the average becomes 20.0 MB; and when the resident program F is added between the resident programs E and A, the average becomes 21.7 MB. From the above, it is better to add the resident program F between the resident programs B and C or between the resident programs D and E. FIG. 11 illustrates the launch sequence definition in which the resident program F is added between the resident programs B and C.

### Embodiment 2

In the embodiment 1, the content of the launch sequence definition is modified by changing a resident program, which is to be launched first, without modifying the loop of the launch sequence definition. However, the method for modifying the resident program launch sequence is not limited thereto. In an embodiment 2, when modifying a resident program launch sequence, a resident program launch controller 14 randomly determines the sequence of resident programs as illustrated in FIG. 12. According to this method as well, the effects similar to the embodiment 1 can be obtained.

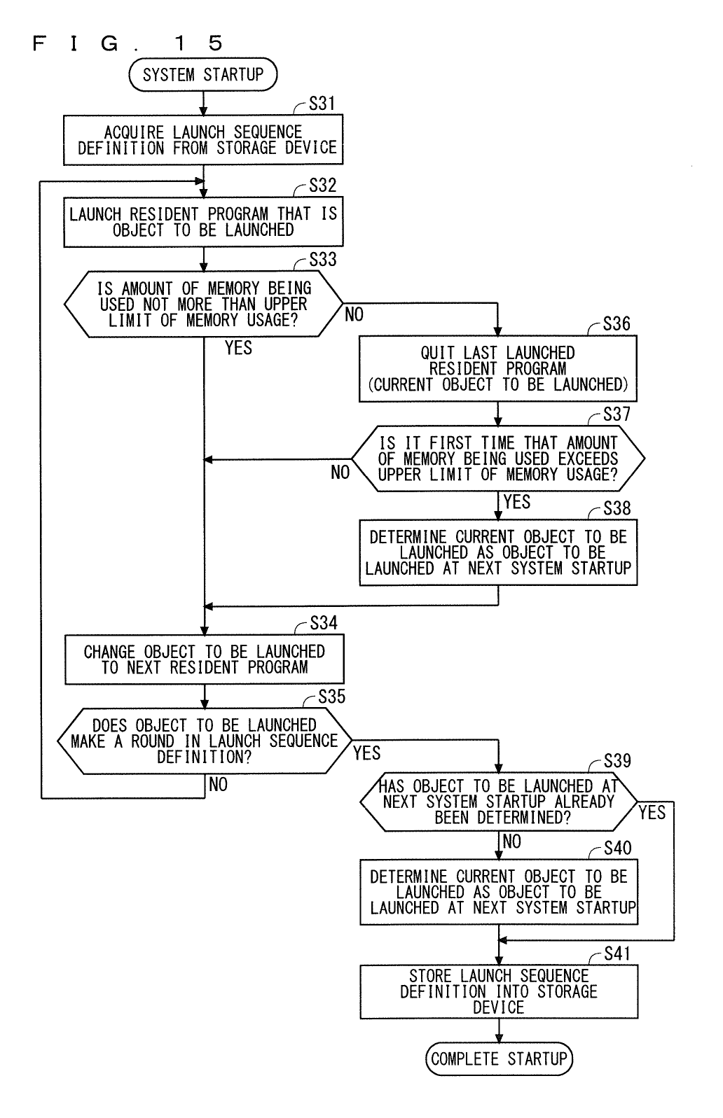

FIG. 13 is a flowchart illustrating the operation of a program execution device 10 according to the embodiment 2 at system startup. In this flowchart, step S16 in FIG. 7 for determining an object to be launched at the next system startup is replaced by step S16a for randomly determining the sequence of resident programs in the launch sequence definition at the next system startup, and therefore, the description thereof will be omitted here.

### Embodiment 3

In the embodiment 1, when memory shortage occurs due to the launch of a resident program, subsequent resident programs are not launched. For example, in the example in FIG. 5, when memory shortage occurs due to the launch of the resident program C as illustrated in part (c) of FIG. 5, the system startup process is ended with the state illustrated in part (d) of FIG. 5, and the resident programs D and E are not launched.

However, in the state illustrated in part (d) of FIG. 5, the amount of memory being used is 30 MB and there are 20 MB left up to 50 MB which is the upper limit of memory usage. Therefore, the resident program D having 15 MB as an amount of memory to be used must be executable. An embodiment 3 prevents the memory capacity from being not sufficiently effectively used as in the above-mentioned case.

Specifically, a program execution unit 11 in the program execution device 10 according to the embodiment 3 repeatedly performs, according to the launch sequence definition, an operation for causing the next resident program to reside by skipping the resident program which is the cause of the memory shortage. The repeated operation is executed until a round of the resident programs in the launch sequence definition is ended.

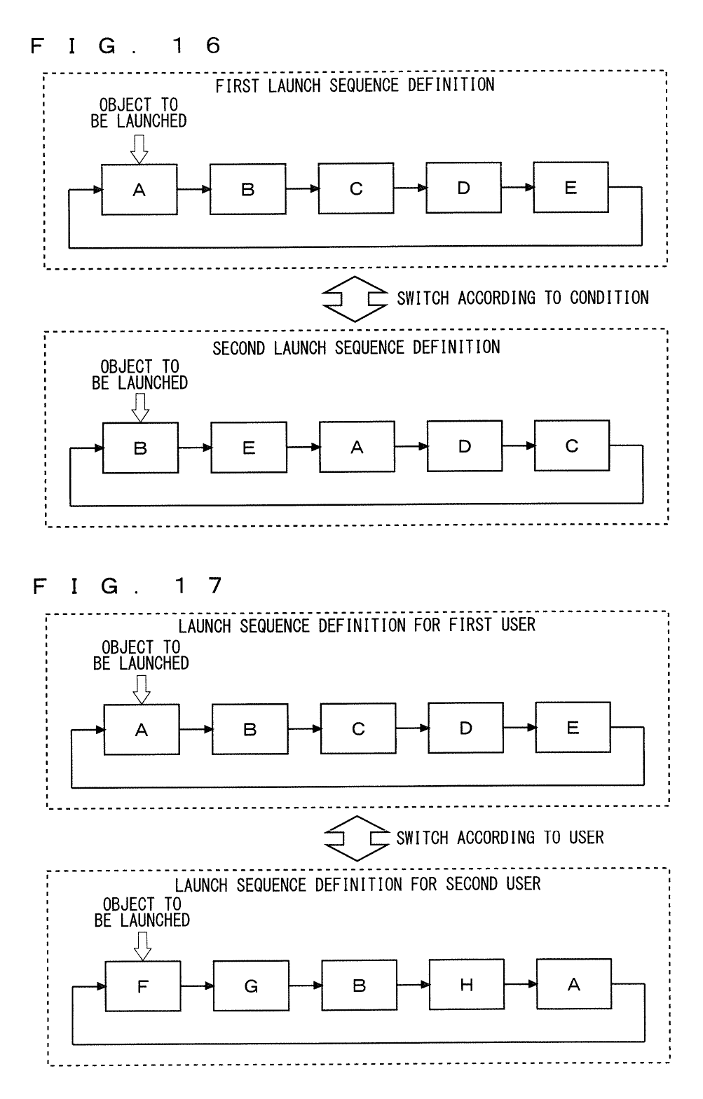

This operation will be described with reference to FIG. 14. FIG. 14 illustrates the operation based on the launch sequence definition illustrated in FIG. 3. In this case too, it is supposed that the memory capacity of the program execution device 10 is 80 MB, and the upper limit of memory usage is 50 MB.

When the power source of the program execution device 10 is turned on by the start switch 21 to start the system, the program execution unit 11 launches the resident program A that is an object to be launched according to the launch sequence definition (FIG. 3) stored in the storage unit 12. As illustrated in part (a) of FIG. 14, launching the resident program A only uses the memory capacity of 20 MB which is lower than the upper limit of memory usage. In this case, the program execution unit 11 changes the object to be launched to the resident program B, and launches the resident program B. As illustrated in part (b) of FIG. 14, even if the resident programs A and B are launched, the amount of memory being used is 30 MB which is still lower than the upper limit of memory usage. Therefore, the program execution unit 11 changes the object to be launched further to the resident program C, and launches the resident program C.

As illustrated in part (c) of FIG. 14, when the resident programs A, B, and C are launched, the amount of memory being used reaches 60 MB which exceeds the upper limit of memory usage, and thus, memory shortage occurs. In this case, the program execution unit 11 quits the resident program C (that is, the last launched resident program) which is the cause for which the amount of memory being used exceeds the upper limit of memory usage, and after that, changes the object to be launched to the resident program D and launches the resident program D. As illustrated in part (d) of FIG. 14, even if the resident programs A, B, and D are launched, the amount of memory being used is 45 MB which does not cause memory shortage. In this case, the program execution unit 11 changes the object to be launched to the resident program E, and launches the resident program E.

As illustrated in part (e) of FIG. 14, when the resident programs A, B, D, and E are launched, the amount of memory being used is 70 MB which causes memory shortage. In this case, the program execution unit 11 quits the resident program E which is the cause for which the amount of memory being used exceeds the upper limit of memory usage, and after that, changes the object to be launched to the resident program A. With this, the object to be launched makes a round of the resident programs in the launch sequence definition, and thus, the process for launching a resident program is ended.

The resident program launch controller 14 modifies the launch sequence definition such that the resident program, which becomes the first cause for which the amount of memory being used exceeds the upper limit of memory usage, is launched first at the next system startup. In the operation illustrated in FIG. 14, memory shortage occurs for the first time when the resident program C is launched, and therefore, the resident program C is set as the resident program to be launched first at the next system startup. That is, the resident program launch controller 14 stores the launch sequence definition in which the resident program C is the object to be launched as illustrated in FIG. 6 into the storage unit 12. Thus, at the next system startup, the operation similar to the above operation is performed after the resident program C is first launched.

As described above, in the present embodiment, when memory shortage occurs due to the launch of a resident program, a resident program which can be launched instead is searched, and if such resident program is found, this program is launched. Accordingly, the number of the residing resident programs can be increased more than the embodiment 1.

FIG. 15 is a flowchart illustrating the operation of the program execution device 10 according to the embodiment 3 at system startup. The operation described with reference to FIG. 14 is implemented by the program execution device 10 performing the operation according to the flowchart.

When the power source of the program execution device 10 is turned on by the start switch 21 to start the system, the program execution unit 11 acquires the launch sequence definition from the storage unit 12 (step S31), and launches a resident program that is an object to be launched (step S32). Then, the resource monitor 13 monitors an amount of memory being used in the program execution device 10 to confirm whether or not the amount of memory being used is not more than the upper limit of memory usage (step S33).

If the amount of memory being used is not more than the upper limit of memory usage (YES in step S33), an object to be launched is changed to the next resident program (step S34). In this case, if the object to be launched does not make a round of the resident programs in the launch sequence definition (NO in step S35), the process returns to step S32.

On the other hand, in step S33, if the amount of memory being used exceeds the upper limit of memory usage (NO in step S33), the program execution unit 11 quits the last launched resident program (step S36). In this case, if it is the first time that the amount of memory being used exceeds the upper limit of memory usage (YES in step S37), the resident program launch controller 14 determines the resident program, which is the current object to be launched, as the object to be launched at the next system startup (step S38), and then, the process proceeds to step S34. If it is not the first time that the amount of memory being used exceeds the upper limit of memory usage (NO in step S37), the process in step S38 is not performed, and the process proceeds to step S34.

The process described above is repeatedly performed. When the object to be launched makes a round of the resident programs in the launch sequence definition (YES in step S35), it is confirmed whether or not the object to be launched at the next system startup has already been determined (that is, whether or not the process in step S38 has already been performed) (step S39). If the object to be launched at the next system startup has not yet been determined (NO in step S39), the resident program launch controller 14 determines the resident program, which is the current object to be launched, to be the object to be launched at the next system startup (step S40), and stores the launch sequence definition specified as such in the storage unit 12 (step S41).

If the object to be launched at the next system startup has already been determined (YES in step S39), the resident program launch controller 14 stores the launch sequence definition in which the object to be launched is specified as determined in step S38 into the storage unit 12 without performing the process in step S40 (step S41). Thus, the startup process of the system is completed.

Even in the embodiment 3, in the case where the amount of memory to be used by each resident program is recognized beforehand, it may be determined whether memory shortage will occur or not without actually launching a resident program.

In the embodiment 3, the resident program launch controller 14 modifies the content of the launch sequence definition such that the resident program, which is the first cause for which the amount of memory being used exceeds a certain value, is to be launched first at the next system startup without modifying the loop in the launch sequence definition. However, when modifying the launch sequence definition, the resident program launch controller 14 may randomly determine the sequence of resident programs in the launch sequence definition by applying the embodiment 2.

### Embodiment 4

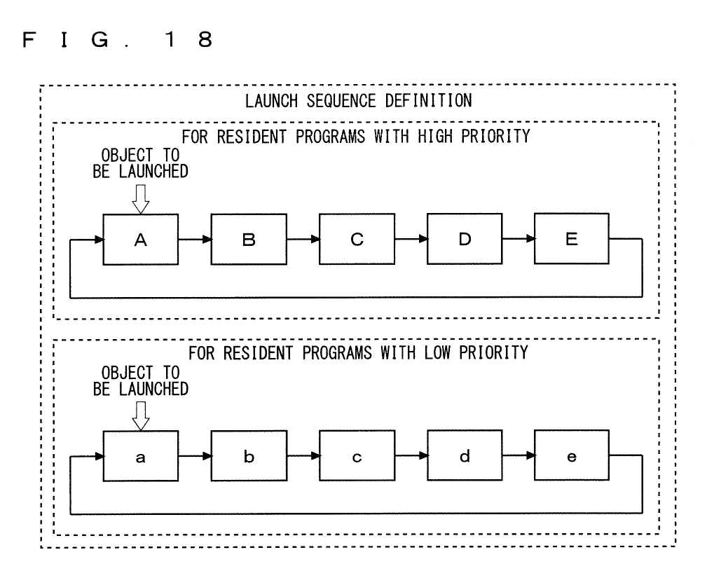

While the embodiment 1 describes the example in which the program execution device 10 uses only one launch sequence definition, an embodiment 4 shows an example in which the program execution device 10 uses a plurality of launch sequence definitions. Specifically, a resident program launch controller 14 manages a plurality of launch sequence definitions illustrated in FIG. 16, and switches the launch sequence definition to be used by the program execution unit 11 according to a predetermined condition. The other operation is similar to the embodiment 1 (FIG. 7).

For example, in the case where a plurality of launch sequence definitions is switched according to a current position condition, a plurality of launch sequence definitions corresponding to the respective current position conditions is stored in the storage unit 12. The resident program launch controller 14 acquires a current position at startup of the program execution device 10, and issues an instruction to read the launch sequence definition according to the current position from the storage unit 12 to the program execution unit 11 in step S11 in FIG. 7.

Examples of considerable conditions of criteria for determining which launch sequence definition should be selected include a weather condition and a user condition, besides the current position condition. The operation of the program execution device 10 using such conditions may be similar to the operation described above, and the resident program launch controller 14 may issue an instruction to read the launch sequence definition according to a current weather or a user from the storage unit 12 to the program execution unit 11 in step S11 in FIG. 7.

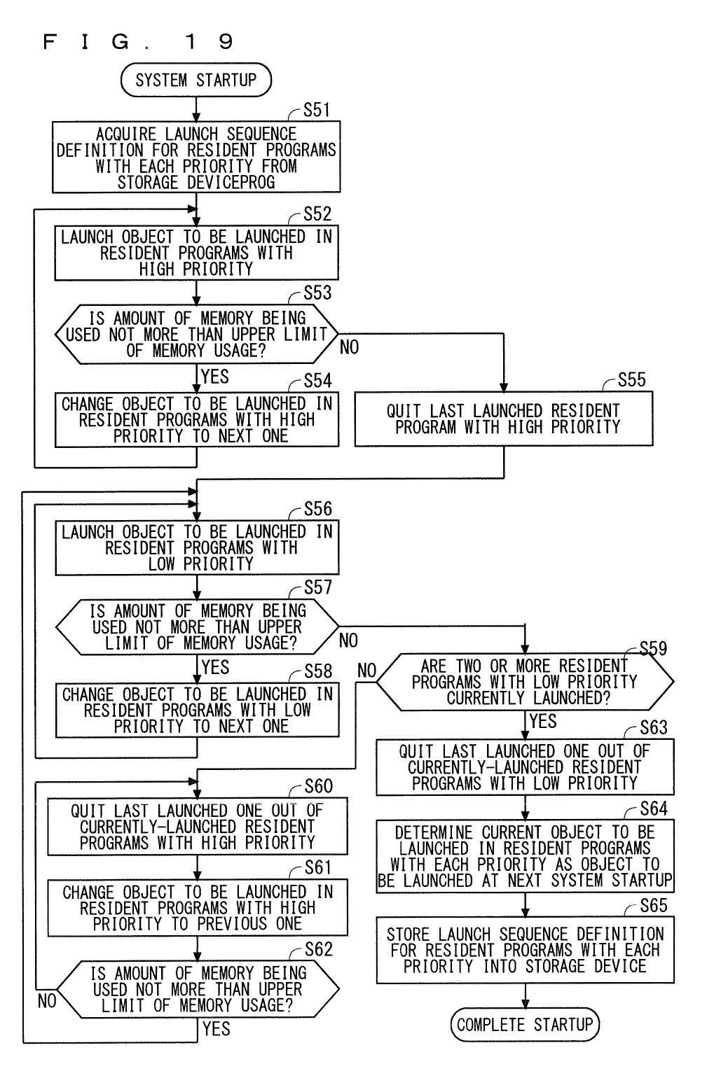

According to the embodiment 4, the launch sequence definition can be used according to a current position or weather at the time when the program execution device 10 is started. Further, the launch sequence definition can be switched for each user using the program execution device 10. Particularly, in the case where an application can be independently introduced by each user, resident programs introduced by each of users may differ as illustrated in FIG. 17, and therefore, the way in which the launch sequence definition can be switched for each user is quite effective.

### Embodiment 5

An embodiment 5 describes a program execution device 10 configured such that priority is specified for each of a plurality of resident programs, and a resident program launch controller 14 manages a plurality of launch sequence definitions, each of which corresponds to each priority.

FIG. 18 illustrates an example in which resident programs are classified into resident programs A to E having high priority and resident programs a to e having low priority, and a launch sequence definition corresponding to each priority is used. At system startup, the program execution unit 11 launches each resident program according to the launch sequence definition corresponding to the priority of the resident program.

In this case, the resident programs having low priority may be launched only when there is room in memory capacity even after all of the resident programs having high priority are launched. However, in this case, the resident programs with low priority may not be launched at all. In view of this, the sequence in which the resident programs are launched is preferably determined such that at least one of resident programs with each priority can be executed. If at least one of resident programs with each priority is executed at system startup, all of the resident programs with low priority have a chance to be launched during the system is repeatedly started and shut down, and this can prevent the generation of the resident program which is not at all launched.

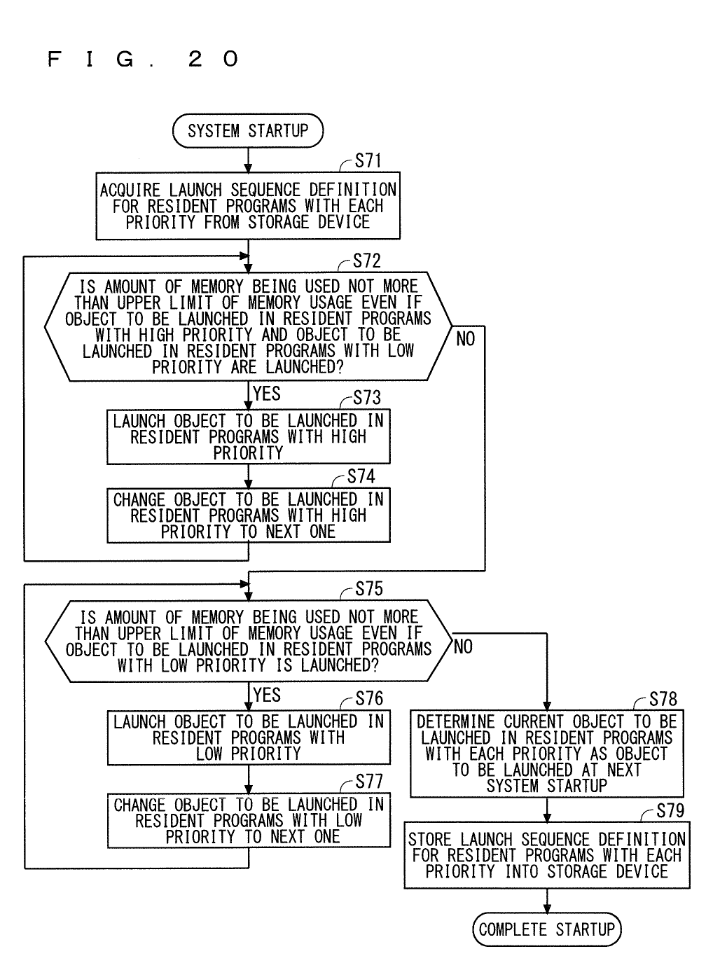

FIG. 19 is a flowchart illustrating the operation of the program execution device 10 according to the embodiment 5 at system startup. This flowchart illustrates the operation in which resident programs with high priority and resident programs with low priority are specified, and the program execution device 10 executes at least one of the resident programs with each priority. Note that the storage unit 12 in the program execution device 10 stores the launch sequence definition for resident programs with high priority and the launch sequence definition for resident programs with low priority as illustrated in FIG. 18.

When the power source of the program execution device 10 is turned on by the start switch 21 to start the system, the program execution unit 11 acquires the launch sequence definition for resident programs with high priority and the launch sequence definition for resident programs with low priority from the storage unit 12 (step S51). Then, the program execution unit 11 launches an object to be launched in the resident programs with high priority (step S52). Next, the resource monitor 13 monitors an amount of memory being used in the program execution device 10 to confirm whether or not the amount of memory being used is not more than the upper limit of memory usage (step S53). If the amount of memory being used is not more than the upper limit of memory usage (YES in step S53), an object to be launched in the resident programs with high priority is changed to the one next to the current object to be launched (step S54), and then, the process returns to step S52.

When the amount of memory being used exceeds the upper limit of memory usage due to the repeated processes in steps S52 to S54 (NO in step S53), the program execution unit 11 quits the last launched resident program with high priority (step S55). With the process so far, the resident programs with high priority are launched within the range in which the amount of memory being used does not exceed the upper limit of memory usage.

Then, the program execution unit 11 launches an object to be launched in the resident programs with low priority (step S56). Next, the resource monitor 13 confirms whether or not the amount of memory being used is not more than the upper limit of memory usage (step S57). If the amount of memory being used is not more than the upper limit of memory usage (YES in step S57), an object to be launched in the resident programs with low priority is changed to the one next to the current object to be launched (step S58), and then, the process returns to step S56.

If the amount of memory being used exceeds the upper limit of memory usage (NO in step S57), the program execution unit 11 confirms whether or not two or more resident programs with low priority are launched (step S59). Note that, since step S56 is executed before step S59, at least one of the resident programs with low priority has already been launched in step S59.

When only one resident program with low priority is launched (NO in step S59), the last launched one of the currently-launched resident programs with high priority is quitted in order to reduce the amount of memory being used while keeping the operation of the launched resident program with low priority (step S60). Further, the object to be launched in the resident programs with high priority is changed to the previous one of the current object to be launched (step S61). Thus, the object to be launched in the resident programs with high priority is the resident program quitted in step S60. Thereafter, the resource monitor 13 again confirms whether or not the amount of memory being used is not more than the upper limit of memory usage (step S62), and if the amount of memory being used exceeds the upper limit of memory usage (NO in step S62), the process returns to step S60. That is, the processes in steps S60 and S61 are repeatedly performed until the amount of memory being used becomes not more than the upper limit of memory usage. With this, the amount of memory being used can be lowered to be equal to or less than the upper limit of memory usage, while the operation of the only resident program with low priority which is currently launched is continued.

When the amount of memory being used becomes not more than the upper limit of memory usage (YES in step S62), the process returns to step S56. Thus, in the case where the amount of space of memory increased by the process in step S60 is large, the resident program with low priority can further be launched, whereby the memory capacity can effectively be utilized.

On the other hand, when two or more resident programs with low priority are launched in step S59 (YES in step S59), the last launched one of the currently-launched resident programs with low priority is quitted in order to lower the amount of memory being used to be equal to or less than the upper limit of memory usage while keeping the operation of the resident program with high priority (step S63). Thereafter, the resident program launch controller 14 determines the current object to be launched in the resident programs with each priority to be the object to be launched at the next system startup (step S64), and stores the launch sequence definition for resident programs with each priority in the storage unit 12 (step S65). Thus, the startup process of the system is completed.

In the operation in FIG. 19, it is determined whether or not memory shortage occurs (steps S53 and S57) after a resident program is actually launched (step S52 and S56). However, if the amount of memory to be used by each resident program is recognized in advance, it may be determined whether or not memory shortage will occur before the launch of a resident program. In this case, the resident program may be launched and reside only when it is determined that memory shortage will not occur.

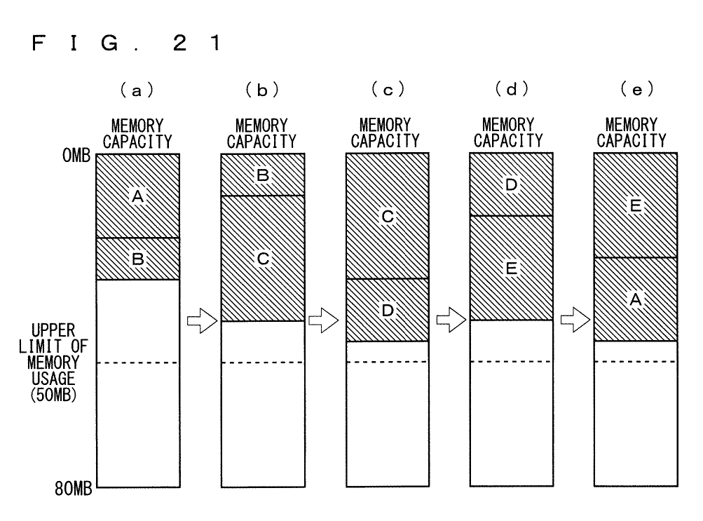

The operation of the program execution device 10 at system startup when an amount of memory to be used by a resident program can be determined beforehand will be described below. FIG. 20 is a flowchart illustrating this operation.

When the power source of the program execution device 10 is turned on by the start switch 21 to start the system, the program execution unit 11 acquires the launch sequence definition for resident programs with high priority and the launch sequence definition for resident programs with low priority from the storage unit 12 (step S71). Then, the program execution unit 11 predicts an amount of memory to be used when an object to be launched in the resident programs with high priority and an object to be launched in the resident programs with low priority are launched on the basis of the current amount of memory being used in the program execution device 10 detected by the resource monitor 13, the amount of memory to be used by the object to be launched in the resident programs with high priority, and the amount of memory to be used by the object to be launched in the resident programs with low priority, and determines whether or not the amount of memory to be used at that time is not more than the upper limit of memory usage (step S72).

When determining that the amount of memory to be used is not more than the upper limit of memory usage even if the object to be launched in the resident programs with high priority and the object to be launched in the resident programs with low priority are launched (YES in step S72), the program execution unit 11 launches the object to be launched in the resident programs with high priority (step S73). Then, the object to be launched in the resident programs with high priority is changed to the one next to the current object to be launched (step S74), and then, the process returns to step S72. With the processes in steps S72 to S74, the resident programs with high priority are launched within the range in which the amount of memory being used does not exceed the upper limit of memory usage, while the memory capacity required for launching the object to be launched in the resident programs with low priority is left.

Thereafter, when it is determined that the amount of memory to be used exceeds the upper limit of memory usage if the object to be launched in the resident programs with high priority and the object to be launched in the resident programs with low priority are launched (NO in step S72), the program execution unit 11 predicts an amount of memory to be used when the object to be launched in the resident programs with low priority is launched on the basis of the current amount of memory being used detected by the resource monitor 13 and the amount of memory to be used by the object to be launched in the resident programs with low priority, and determines whether or not the amount of memory to be used at that time is not more than the upper limit of memory usage (step S75).

When determining that the amount of memory to be used is not more than the upper limit of memory usage even if the object to be launched in the resident programs with low priority is launched (YES in step S75), the program execution unit 11 launches the object to be launched in the resident programs with low priority (step S76). Then, the object to be launched in the resident programs with low priority is changed to the one next to the current object to be launched (step S77), and then, the process returns to step S75. As previously described, in steps S72 to S74, the memory capacity needed to launch the object to be launched in the resident programs with low priority is ensured, and therefore, YES determination is made at least once in step S75, whereby at least one of the resident programs with low priority is launched.

On the other hand, when it is determined that the amount of memory to be used exceeds the upper limit of memory usage when the object to be launched in the resident programs with low priority is launched (NO in step S75), another resident program with low priority is not launched. In this case, the resident program launch controller 14 determines the current object to be launched in the resident programs with each priority to be the object to be launched at the next system startup (step S78), and then, stores the launch sequence definition for resident programs with each priority in the storage unit 12 (step S79). Thus, the startup process of the system is completed.

Note that the priority of each resident program may not be fixed. For example, the priority may be changed according to a predetermined condition (condition such as a current position, weather, or user).

### Embodiment 6

While the embodiments 1 to 5 describe that the program execution unit 11 launches a resident program only at system startup, a program execution unit 11 in an embodiment 6 changes a resident program to reside at a fixed cycle according to a launch sequence definition after system startup.

Specifically, the program execution unit 11 executes the process in the embodiment 1 (FIG. 7) after system startup, and then, quits the most previously launched resident program out of the residing resident programs every time a certain period of time has elapsed, and then, executes again the process in FIG. 7.

This operation will be described with reference to FIG. 21. When the process in FIG. 7 is executed on the basis of the launch sequence definition in FIG. 3 at system startup, the resident programs A and B are launched as illustrated in part (a) of FIG. 21. After a certain period of time has elapsed after that, the resident program A which is most previously launched out of the resident programs A and B is quitted, and then, the process in FIG. 7 is again executed. With this, the resident program C is launched, which generates the state in which the resident programs B and C reside as illustrated in part (b) of FIG. 21. When such operation is repeated with a fixed cycle, the state is changed to the state in which the resident programs C and D reside as illustrated in part (c) of FIG. 21, the state in which the resident programs D and E reside as illustrated in part (d) of FIG. 21, and the state in which the resident programs E and A reside as illustrated in part (e) of FIG. 21, and then, returns to the state illustrated in part (a) of FIG. 21. This operation is repeated until the program execution device 10 is turned off.

In the present embodiment, the resident program is switched according to the launch sequence definition during the system is operated, whereby the effect similar to the embodiment 1 can be obtained without shutting down the operation of the system. The present embodiment is particularly effective for a device of which power source is not frequently turned off, such as a smartphone. Notably, in the case where the process in FIG. 7 is repeatedly executed, when the operation of the system is shut down, the resident program next to the last residing resident program, that is, the resident program which is the cause for which the amount of memory being used exceeds the upper limit of memory usage, is launched first at the next system startup. Alternatively, the embodiment 2 may be applied to randomly determine the sequence of resident programs in the launch sequence definition used at the next system startup.

Further, while the embodiment 5 describes an example in which the process in the embodiment 1 (FIG. 7) is executed at a fixed cycle after the system startup, the process in the embodiment 3 (FIG. 15) may be executed at a fixed cycle.

The embodiments of the present invention can be freely combined, modified or omitted, as appropriate, within the scope of the invention.

While the invention has been shown and described in detail, the foregoing description is in all aspects illustrative and not restrictive. It is therefore understood that numerous modifications and variations can be conceived without departing from the scope of the invention.

### REFERENCE SIGNS LIST

10: program execution device
11: program execution unit
12: storage unit
13: resource monitor
14: resident program launch controller
21: start switch
22: display
23: audio output device

1. A program execution system comprising:
a processor to execute a program; and
a memory to store said program to perform processes, when being executed by said processor, of:
sequentially launching a plurality of resident programs, at system startup, according to a launch sequence definition that is information specifying a sequence in which said plurality of resident programs is to be launched; and
modifying said launch sequence definition at current system startup and uses the modified launch sequence definition at next system startup, when an amount of resources being used exceeds a certain value due to the launch of said plurality of resident programs.

2. The program execution system according to claim 1,
wherein said processor inhibits a resident program, which is a cause for which an amount of resources being used exceeds said certain value, from residing.

3. The program execution system according to claim 1, wherein:
a sequence of said plurality of resident programs in said launch sequence definition is specified in a loop manner; and
said processor modifies said launch sequence definition by changing a resident program which is to be launched first.

4. The program execution system according to claim 3,
wherein said processor modifies said launch sequence definition such that a resident program, which is a cause for which an amount of resources being used exceeds said certain value, is launched first at next system startup.

5. The program execution system according to claim 1,
wherein said processor repeatedly performs, according to said launch sequence definition, an operation for skipping a resident program, which is a cause for which an amount of resources being used exceeds said certain value, and causing the next resident program to reside.

6. The program execution system according to claim 5, wherein:
a sequence of said plurality of resident programs in said launch sequence definition is specified in a loop manner, and
said processor modifies said launch sequence definition such that a resident program, which is the first cause for which an amount of resources being used exceeds said certain value, is launched first at next system startup.

7. The program execution system according to claim 1,
wherein, when modifying said launch sequence definition, said processor randomly determines a sequence of said plurality of resident programs in said launch sequence definition at next system startup.

8. The program execution system according to claim 1,
wherein, when a new resident program is introduced, said processor adds said new resident program at any position in a sequence of said plurality of resident programs in said launch sequence definition.

9. The program execution system according to claim 8,
wherein, when adding a new resident program to said launch sequence definition, said processor adds said new resident program at a position where an average of amounts of resources to be used by said new resident program and resident programs located before and after the position where said new resident program is to be added becomes the closest to an average of amounts of resources to be used by all resident programs included in said launch sequence definition.

10. The program execution system according to claim 1,
wherein said processor manages the plurality of said launch sequence definitions, and switches said launch sequence definition to be used according to a predetermined condition.

11. The program execution system according to claim 1, wherein:
priority is set for each of the plurality of resident programs;
said processor manages the plurality of said launch sequence definitions for each priority; and
said processor sequentially launches each resident program according to said launch sequence definition corresponding to the priority of the resident program at system startup.

12. The program execution system according to claim 11,
wherein said processor determines a sequence of said plurality of resident programs such that at least one of resident programs with each priority is executable.

13. The program execution system according to claim 11,
wherein said priority set for each of said plurality of resident programs is changed according to a predetermined condition.

14. The program execution system according to claim 1,
wherein, after system startup, said processor changes a resident program to reside at a fixed cycle according to said launch sequence definition.

15. The program execution system according to claim 14, wherein:
a sequence of said plurality of resident programs in said launch sequence definition is specified in a loop manner; and
when a resident program is launched after system startup, said processor modifies said launch sequence definition such that a resident program next to the last residing resident program is launched first at next system startup.

16. A method for launching resident programs comprising:
launching a resident program, at startup of a program execution system, according to a launch sequence definition that is information specifying a sequence in which a plurality of resident programs is launched; determining whether or not an amount of resources being used exceeds a certain value due to the launch of said resident program, before or after said resident program is launched; and
modifying said launch sequence definition at current system startup and using the modified launch sequence definition at next system startup, when it is determined that an amount of resources being used exceeds said certain value due to the launch of said resident program.
